(19) United States
(12) Patent Application Publication
(10) Pub. No.: US 2009/0237507 A1
(43) Pub. Date: Sep. 24, 2009

(54) Apparatus for logging motor vehicle speed and time

(76) Inventor: Karl F. Milde, JR., Mahopac, NY (US)

Correspondence Address: MILDE & HOFFBERG, LLP, 10 BANK STREET, SUITE 460, WHITE PLAINS, NY, 10606, US

(21) Appl. No.: 12/148,599

(22) Filed: Apr. 21, 2008

Related U.S. Application Data
(62) Division of application No. 61/070,088, filed on Mar. 20, 2008.

(51) Int. Cl. H04N 7/18

(52) U.S. Cl. 348/148; 348/E07.085

(57) ABSTRACT

The present invention concerns an apparatus for recording the speed of a motor vehicle which includes:
(a) a video camera, adapted to view a speedometer of the vehicle and produce a video signal representing the video image of the speedometer; and
(b) an electronic device, coupled to said video camera, for receiving the video signal and continuously storing the most recent portion of the video image.

### CROSS-REFERENCE TO RELATED APPLICATION

This application claims priority from the Provisional Application No. ______ filed, Mar. 20, 2008.

### BACKGROUND OF THE INVENTION

It often happens that a motor vehicle is stopped for speeding by a police officer when, in fact, its speed was less than what the officer alleges it to be. It is well known that police officers are under pressure from their superiors to issue citations for motor vehicle speeding, and, as a result, they either report an inflated speed or cite a motorist for speeding when in fact the speed was within legal limits.

In traffic court, it is difficult if not impossible to convince a judge that the officer erred in writing a traffic citation. The contest becomes one of “he said/she said”, with the officer's credibility weighed against that of the accused. Without any evidence by the motorist that he or she was not, in fact, speeding, the judge is forced to decide that speeding had, if fact, occurred. What is needed is a simple and inexpensive device which allows a motorist to prove how fast he or she was going just prior to being stopped by the police officer.

### SUMMARY OF THE INVENTION

The above objective, as well as other objectives which will become apparent to those skilled in the art, are achieved, in accordance with the present invention, by providing apparatus for recording the speed of a motor vehicle which includes:

(a) a video camera, adapted to view a speedometer of the vehicle and produce a video signal representing the video image of the speedometer; and

(b) an electronic device, coupled to said video camera, for receiving the video signal and continuously storing the most recent portion of the video image.

The apparatus thus operates in a manner similar to the flight recorder on an aircraft, in that it makes a record of the speed of the vehicle during the most recent period of time, which record may be “frozen” and examined later if desired. Since the storage device used by the apparatus is of limited size, it is continuously being “overwritten” with the most recent data, thus erasing the old data to make room for the new.

The apparatus according to the invention also preferably includes a display device for receiving and displaying the stored video image. If the vehicle operator has such a device on board when he/she is stopped by a police officer, he/she can show the officer the video clip of his speedometer during the precise time that the officer alleged the vehicle was speeding.

To avoid losing data which may become valuable “evidence” in a dispute with the officer of the law about the speed of the vehicle, the electronic device preferably includes a switch which, when activated, prevents deletion of said portion of the stored video image. This switch may take the form of a button on the device which, when pressed, stops the recording of new video image date on the device memory.

The electronic device preferably uses a “flash memory” chip for storing the video image data. This chap may then be removed from its docking slot in the electronic device housing and inserted in a docking slot in the display device. Removal from the docking slot has the effect of “freezing” the contents of the memory chip. In this case, it may not be necessary to provide the switch, referred to above, for interrupting the recording of new data.

The video camera used to capture the image of the speedometer is preferably attached to either the dashboard or the steering wheel of the vehicle, preferably via a flexible joint permitting manual adjustment of the position of the video camera.

Finally, the electronic device of the apparatus according to the invention preferably further includes a clock for producing a signal representing the date and time, so that the electronic device may continuously store the date and time contemporaneously with the video image. The display device may then receive and display the stored date and time together with the video image, and superimpose the date and time on the display of the video image.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a representational diagram of the steering wheel and dashboard of a motor vehicle, to which is added the video camera and electronic device of the present invention.

FIG. 2 is a side view of a steering wheel and a dashboard of motor vehicle showing how a video camera may be positioned to view the speedometer.

FIG. 3 is a representational diagram showing a manually adjustable fixture for the video camera according to the invention.

FIG. 4 is a block diagram showing the video camera and the electronic device, wherein the latter incorporates a flash memory chip.

FIG. 5 is a representational diagram of a display device which is capable of displaying a video image, with superimposed date and time, obtained from the recorded data on the flash memory chip.

### DESCRIPTION OF THE PREFERRED EMBODIMENTS

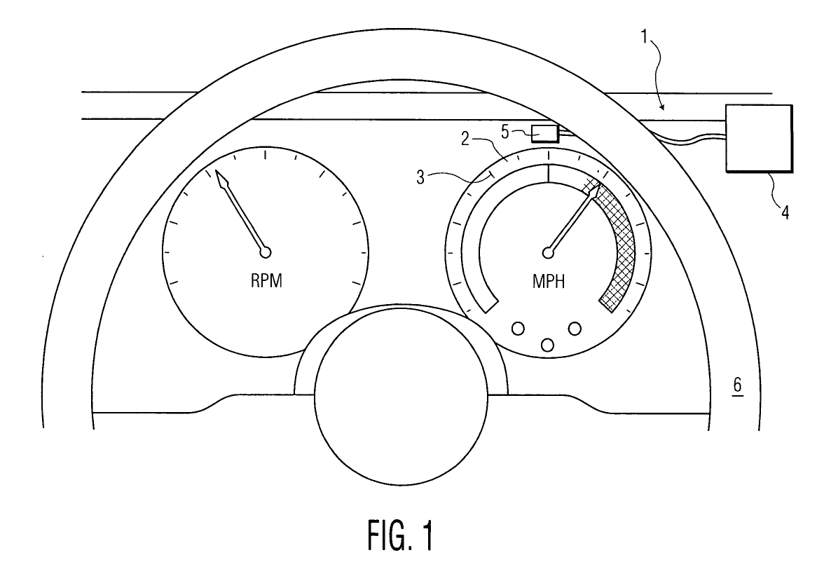

The preferred embodiments of the present invention will now be described with reference to FIGS. 1-5 of the drawings. Identical elements in the various figures are designated with the same reference numerals.

FIGS. 1-5 illustrate a simple and inexpensive apparatus for recording the speed of a motor vehicle. Essentially, the system records a video of the speedometer for a given interval—say the last 30 minutes of time—and stores this information on a memory chip together with the current date and time.

FIG. 1 illustrates the dashboard 1 of a motor vehicle with a speedometer 2 that shows the speed on an analog dial with hash marks 3 at five MPH intervals. A small electronic device 4, which receives power from either the cigarette lighter or a solar cell, is connected via a flexible lead to a video camera eye 5 positioned in front of the speedometer 2.

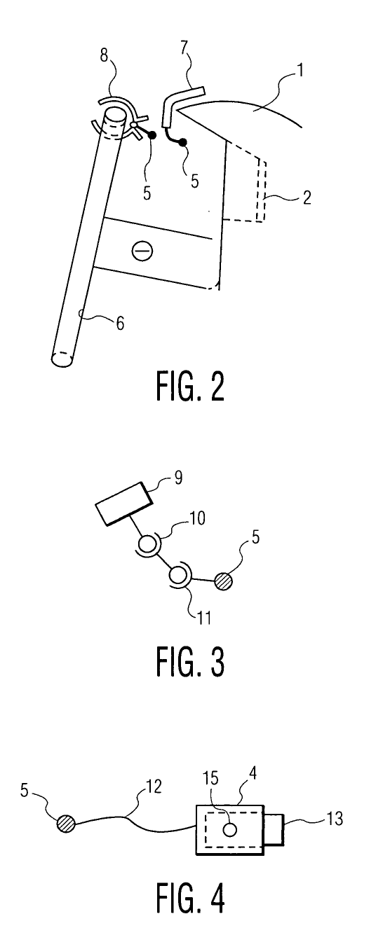

FIG. 2 illustrates how the camera eye 5 may be retained in a position which is unobtrusive to the driver and yet able to view the speedometer 2. For example, the camera may be attached to a device 7 which is removably attached to the dashboard 1 via Velcro, or the camera eye 5 may be attached to the steering wheel 6 by means of a clip 8.

FIG. 3 shows how the camera eye 5 may be attached to a holding device 9 (e.g., either the part 7 or the clip 8) via one or more flexible connectors 10 and 11, which permit manual adjustment of the position of the camera eye.

FIG. 4 shows the camera eye 5 connected via a flexible lead 12 to the electronic device 4. This device adds the date and time to the video image and records them on a memory chip 13. The recording takes place continuously, writing over the old information so that the last 30 minutes of video (or other prescribed period) are continuously recorded on the chip 13. The chip 13 is preferably a flash memory chip.

The electronic device 4 receives either an analog or digital signal representing the video image and stores the video image for later playback. The electronic device also includes an internal clock and stores the current date and time contemporaneously with the video image. Finally, the electronic device may include a button switch for turning off the recording of further video from the video camera eye 5.

The electronic device may be either custom tailored to a particular video camera or may be a commercially available circuit board such as the V-Mate available from SanDisk Company. see www.sandisk.com.

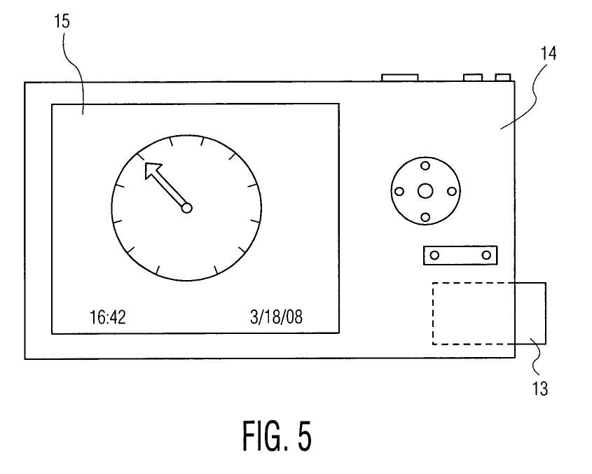

FIG. 5 shows a conventional camera 14 used to display the video stored on the memory chip 13. The image display 15 built into the camera shows the image of the speedometer as well as the date and time information which has been retrieved from the memory chip 13.

When a motorist is stopped by a police officer for speeding, he or she may remove the chip from the recording device 4, thus “freezing” the last 30 minutes of the video recording for later use. If the motorist has a camera handy, he or she may even play the video recording for the police officer to demonstrate the actual speed observed on the speedometer.

Thereafter, if the speed alleged by the police officer does not agree with that shown on the recording, the recording may be shown to the judge at the traffic court.

There has thus been shown and described a novel apparatus for logging motor vehicle speed and time which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. Apparatus for recording the speed of a motor vehicle, said apparatus comprising, in combination:
(a) a video camera, adapted to view a speedometer of the vehicle and produce a video signal representing the video image of the speedometer; and
(b) an electronic device, coupled to said video camera, for receiving the video signal and continuously storing the most recent portion of the video image.

2. The apparatus defined in claim 1, further comprising a display device for receiving and displaying the stored video image.

3. The apparatus defined in claim 1, wherein the electronic device includes a switch which, when activated, prevents deletion of said portion of the stored video image.

4. The apparatus defined in claim 1, wherein said electronic device includes a flash memory for storing the video image.

5. The apparatus defined in claim 4, wherein the flash memory is removable from a housing of the electronic device.

6. The apparatus defined in claim 1, wherein the electronic device overwrites the stored oldest portion of the video image with the most recent portion thereof.

7. The apparatus defined in claim 1, further comprising means for attaching the video camera to a dashboard of the vehicle.

8. The apparatus defined in claim 1, further comprising means for attaching the video camera to a steering wheel of the vehicle.

9. The apparatus defined in claim 7, wherein said attaching means includes a flexible joint permitting manual adjustment of the position of the video camera.

10. The apparatus defined in claim 8, wherein said attaching means includes a flexible joint permitting manual adjustment of the position of the video camera.

11. The apparatus defined in claim 1, wherein said electronic device further includes a clock for producing a signal representing the date and time, and wherein said electronic device continuously stores the date and time contemporaneously with said video image.

12. The apparatus defined in claim 1, further comprising a display device for receiving and displaying the stored date and time and the video image, and wherein said display device superimposes said date and time on the display of said video image.
